(19) United States
(12) Patent Application Publication
(10) Pub. No.: US 2025/0193584 A1
(43) Pub. Date: Jun. 12, 2025

(54) ELECTRONIC DEVICES WITH CONFIGURABLE AUDIO DUCTS

(71) Applicant: Intel Corporation, Santa Clara, CA (US)

(72) Inventors: Mallari Hanchate, Bangalore (IN); Sumod Cherukkate, Bangalore (IN); Praveen Kashyap Ananta Bhat, Bangalore (IN); Satyajit Siddharay Kamat, Bangalore (IN); Samarth Alva, Bangalore (IN)

(21) Appl. No.: 18/534,167

(22) Filed: Dec. 8, 2023

(51) Int. Cl. H04R 1/34; E05F 15/60; E05F 15/70; H04R 1/02; H04R 3/00

(52) U.S. Cl. CPC H04R 1/345; E05F 15/60; E05F 15/70; H04R 1/025; H04R 3/00; E05Y 2201/462; E05Y 2201/484; E05Y 2999/00; H04R 2400/11

(57) ABSTRACT

Disclosed herein are example systems, apparatus, articles of manufacture, and methods for configuring audio ducts of electronic devices. An example electronic device includes a chassis, a speaker, an audio duct formed on an edge of the chassis, and a deployable door movable between a first position adjacent the chassis and covering the audio duct and a second position exposing the audio duct.

### FIELD OF THE DISCLOSURE

This disclosure relates generally to electronic devices and, more particularly, to electronic devices with configurable audio ducts.

### BACKGROUND

Electronic devices that include speakers may include audio ducts in the chassis of the electronic device. The audio ducts are commonly covered with a grill.

### BRIEF DESCRIPTION OF THE DRAWINGS

FIG. 1A is an illustration of a portion of an example electronic device with an example deployable door of an example audio duct in a first position.

FIG. 1B is an illustration of a portion of the example electronic device of FIG. 1A with the deployable door in a second position.

FIG. 1C illustrates an example deployable door.

FIG. 2 is a block diagram of an example implementation of audio duct configuration circuitry.

FIG. 3A is a schematic illustration of a cross-section of a portion of the electronic device of FIG. 1A with the deployable door in the first position.

FIG. 3B is a schematic illustration of a cross-section of a portion of the electronic device of FIG. 1B with the deployable door in the second position.

FIG. 4A is a schematic illustration of the deployable door of FIG. 1A with neither of two example electromagnets energized.

FIG. 4B is a schematic illustration of the deployable door of FIG. 1B with a first of the two electromagnets energized.

FIG. 4C is a schematic illustration of the deployable door of FIG. 1A with a second of the two electromagnets energized.

FIG. 5 is a flowchart representative of example machine readable instructions and/or example operations that may be executed, instantiated, and/or performed by example programmable circuitry to implement the audio duct configuration circuitry of FIG. 2.

FIG. 6 is a block diagram of an example processing platform including programmable circuitry structured to execute, instantiate, and/or perform the example machine readable instructions and/or perform the example operations of FIG. 5 to implement the audio duct configuration circuitry of FIG. 2.

FIG. 7 is a block diagram of an example implementation of the programmable circuitry of FIG. 6.

FIG. 8 is a block diagram of another example implementation of the programmable circuitry of FIG. 6.

In general, the same reference numbers will be used throughout the drawing(s) and accompanying written description to refer to the same or like parts. The figures are not necessarily to scale.

### DETAILED DESCRIPTION

Many electronic devices include speakers. Often speakers are included in the chassis of the electronic devices and an audio duct from the speaker to the exterior of the electronic device may be covered with a grill to allow sound waves to emanate from the electronic device. Some electronic devices such as, for example, laptop computer, dual display devices, tablets, etc. have slim bezels as the sides of their respective chassis. The slim bezel may lead to little or no place of porting speakers towards a display side of the electronic device facing the user. In these example electronic devices, audio ducts are typically ported in the sides of the electronic devices and the sound waves are directed toward the sides and not directed forward toward a user.

Side porting has acoustic limitations because side porting filters high frequency audio content. Thus, there is audio performance degradation in high frequency audio content. The audio performance degradation can be more severe for larger speakers when such speakers are side ported. Side porting constraints high frequency content in two ways. First, the speaker front duct or grating over the audio duct acts as a low pass filter. The larger the duct, the lower the cut off frequency is. Second, high frequency sound waves from a speaker have a naturally narrow sound beam. If the speakers are left or right side ported in an electronic device, high frequency sound has high intensity towards the left or right sides and lower intensity towards the front where the user is located.

In addition, electronic devices that have simple grills in the chassis over audio ducts are not compliant to Ingress Protection rating IP66. A rating of IP66 indicates that the electronic device is dust-tight and protected against powerful water jets. Dust ingress into the audio opening of an electronic device leads to performance degradation because the audio quality decreases as the dust accumulates.

Example electronic devices with configurable audio ducts disclosed herein mitigate degradation of audio from the electronic devices. Example electronic devices disclosed herein include deployable doors that can be moved to direct sound toward users of the electronic devices. In addition, the deployable doors also prevent or lessen the accumulation of dust or other debris within the audio ducts of the electronic devices.

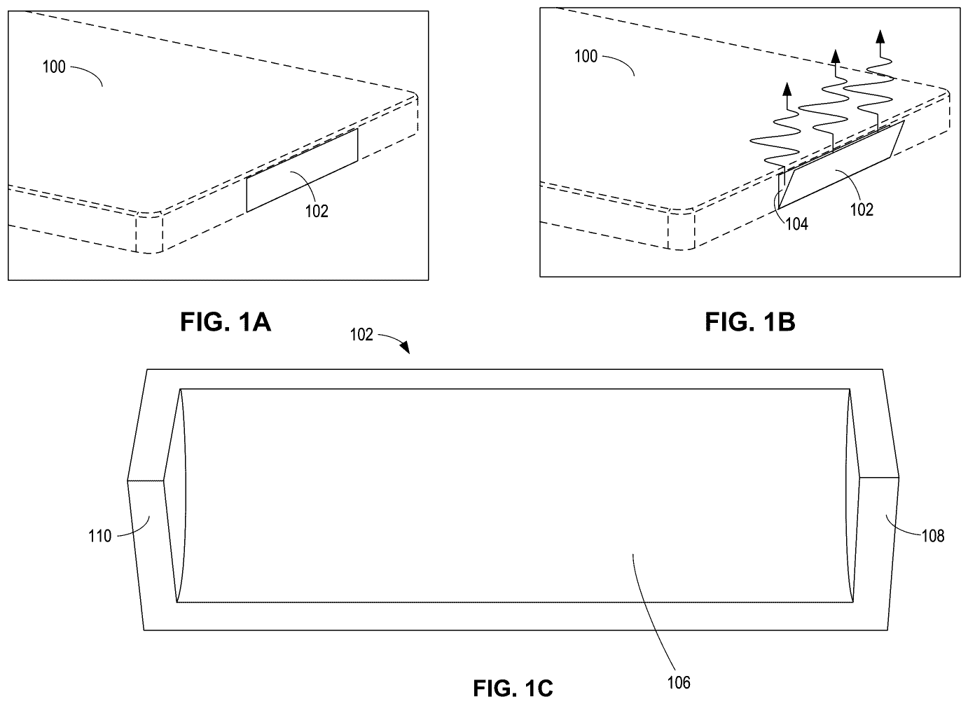

FIG. 1A is an illustration of a portion of an example electronic device 100 with an example deployable door 102 in a first position. In the first position, the deployable door 102 is closed and covers an audio duct. In the first position, the deployable door 104 acts as a cover and prevents ingress of dust or other debris into the electronic device 100.

FIG. 1B is an illustration of a portion of the electronic device 100 of FIG. 1A with the deployable door 102 in a second position. In the second position, the deployable door 102 is in an opened position and exposes the audio duct 104. In the second position, the deployable door 102 acts as an audio diffuser or reflector and directs sound waves from the electronic device 100 toward a user of the electronic device 100. The deployable door 102 also may be referred to as a deflector and/or as a secondary duct. In some examples, there is a deployable door 102 on each of the left and right sides of the electronic device 100. In some examples, there are other numbers of deployable doors (e.g., three, four, etc.).

FIG. 1C shows an example deployable door 102. The deployable door 102 includes an example back wall 106, an example first sidewall 108, and an example second sidewall 110. The back wall 106, first sidewall 108, and second sidewall 110 deflect sound waves to the user. In some examples, the back wall 106 is curved. In some examples, the back 106 is flat and/or slanted. In some examples, one or more of the back wall 106, the first sidewall 108, and/or the second sidewall 110 includes a metal and/or has a coating of metal to further amplify and enhance the sound waves to improve the quality of sound reflection the inside surface of the deployable door 102. In some examples, the coating is a nanocoating. In some examples, the coating includes copper, aluminum, copper-aluminum alloys, etc.

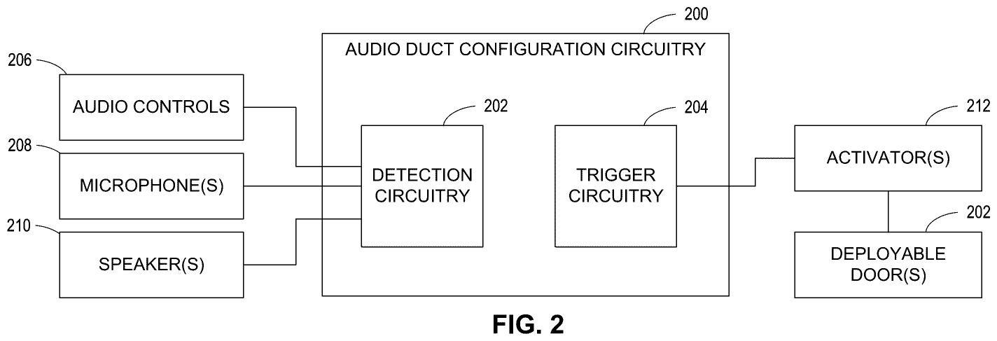

FIG. 2 is a block diagram of an example implementation of audio duct configuration circuitry 200. The audio duct configuration circuitry 200 operates to control the deployable door 102. For example, the audio duct configuration circuitry 200 is used to cause movement of the deployable door 102 between the first position and the second position. As disclosed herein, the audio duct configuration circuitry 200 controls the position of the deployable door 102 based on an operating characteristic of a media program. Media programs include applications and/or media files. In some examples, the audio duct configuration circuitry 200 includes example detection circuitry 202 and example trigger circuitry 204.

The detection circuitry 202 detects operation of a program and, in particular, a program that includes audio. In some examples, the detection circuitry 202 detects programs operating via a system monitor of the electronic device such as, for example, Windows Task Manager. In some examples, the detection circuitry 202 detects programs operating and/or operating characteristics of a program by detecting selection or other operation of example audio controls 206. For example, the detection circuitry 202 detects a muting of a program, a pausing of a program, etc. via the audio controls 206. The audio controls 206 provide information about the operating state and/or volume control state of a program. In some examples, the detection circuitry 202 detects operation of a program via one or more example microphones 208 sensing audio data (i.e., sound waves) emanating from one or more example speakers 210.

The trigger circuitry 204 causes movement of the deployable door 102 between the first position and the second position based on the operating state and/or volume control state of a program determined by the detection circuitry 202. The trigger circuitry 204 causes one or more example actuators 212 to effect movement of the deployable door 102. For example, the actuator 212 may include a switch, and the trigger circuitry 204 may cause the switch to close to send an electric current to an electromagnet, which is used to move the deployable door 102 as disclosed herein.

In some examples, when the detection circuitry 202 detects operation of a program, the trigger circuitry 204 causes the actuator 212 to move the deployable door 102 to the open or second position of FIG. 1B. In the open position, the deployable door 102 directs sound waves from the speaker 210 in the forward direction to the user of the electronic device 100. The redirected sound waves provide a better audio experience for the user because the high frequency sound is directed toward the user and not filtered out. In other words, audio fidelity is increased in the higher audible frequency ranges.

In some examples, when the detection circuitry 202 detects cessation of operation of a program, the trigger circuitry 204 causes the actuator 212 to move the deployable door 102 to the closed or first position of FIG. 1A. In some examples, when the detection circuitry 202 detects a pausing of operation of a program and/or a muting of a program, the trigger circuitry 204 causes the actuator 212 to move the deployable door 102 to the closed or first position of FIG. 1A. In the closed position, the deployable door 102 protects the audio duct 104 from dust.

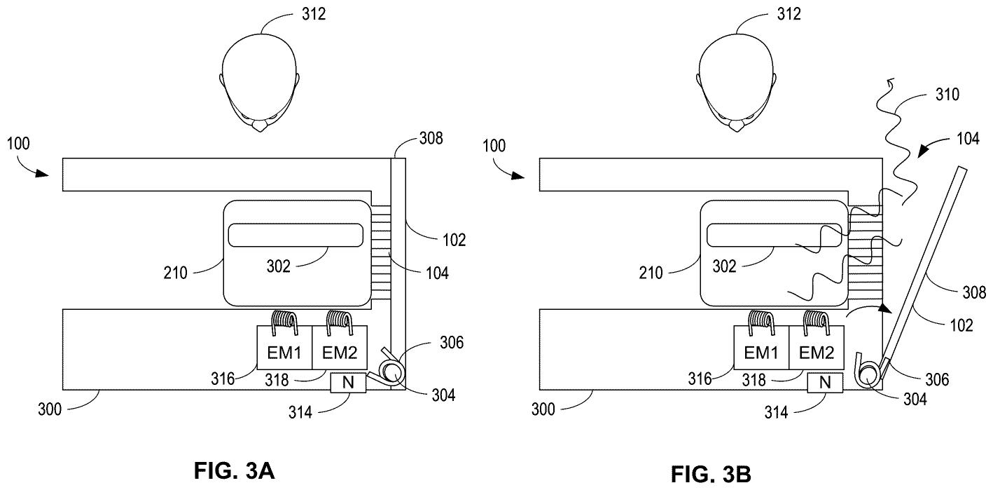

FIG. 3A and FIG. 3B show further details of an example actuator 212. The electronic device 100 includes an example chassis 300. The speaker 210 is disposed within the chassis 300. The speaker 210 includes an example diaphragm 302. The diaphragm 302 vibrates during operation of the speaker 210 to product sound waves.

The electronic device 100 also includes an example biasing member 304. In some examples, the biasing member 304 includes a spring. In some examples, the biasing member 304 includes a torsion spring. In some examples, the biasing member 304 is biased to hold the deployable door 102 in the closed position. The biasing member 304 pivotably couples a first end 306 of the deployable door 102 to the chassis 300 such that the first end 306 of the deployable door 102 is adjacent the chassis 300 in the first position (FIG. 3A) or the second position (FIG. 3B). A second end 308 of the deployable door 102 is positioned against the chassis 300 when the deployable door 102 is in the first position (FIG. 3A). The second end 308 of the deployable door 102 is positioned away from the chassis 300 when the deployable door 102 is in the second position (FIG. 3B). In the second position, the deployable door 102 directs sound waves 310 toward a user 312.

In the first position, the biasing member 304 is magnetically attracted to an example permanent magnet 314. In some examples, the permanent magnet 314 is a magnet included in, for example, a laptop computer to releasably hold a lid of the laptop computer to a base of the laptop computer when the laptop computer is in a closed position. In some examples, the biasing member 304 is biased to place the deployable door 102 in the open position.

In the example of FIG. 3A and FIG. 3B, the actuator 212 includes a first electromagnet 316 and a second electromagnet 318. The first electromagnet 316 and the second electromagnet 318 are selectively charged to attract or repel the biasing member 304. For example, based on an operating state and/or volume control state of a program, the trigger circuitry 204 can cause an electrical current to flow to one or more of the first electromagnet 316 and/or the second electromagnet 318, which selectively magnetizes the respective first electromagnet 316 and/or the second electromagnet 318. The selective magnetization of the first electromagnet 316 and/or the second electromagnet 318 causes the biasing member 304 to move and pivot the deployable door 102 between the first position and the second position.

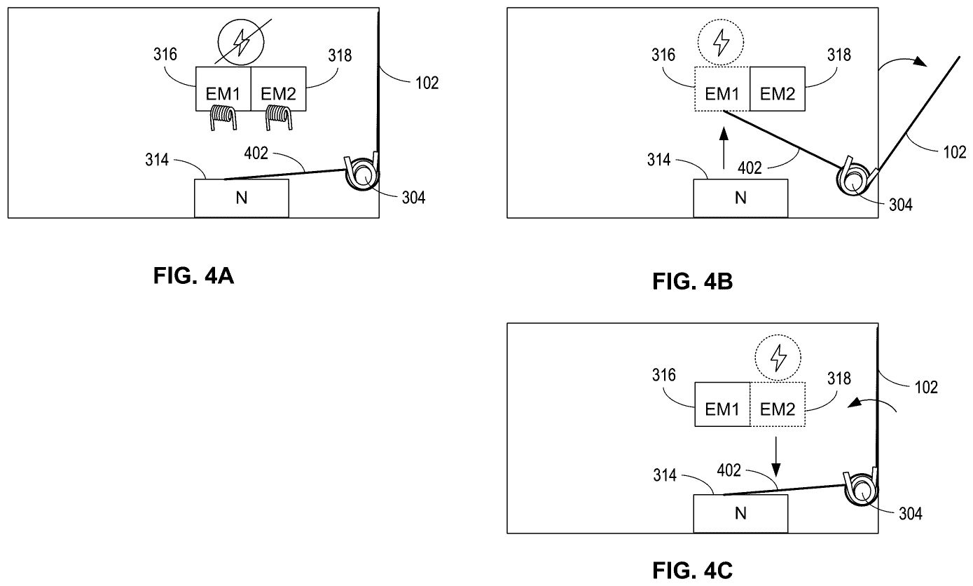

FIG. 4A and FIG. 4B provide further details related to the interaction of the first electromagnet 316 and the second electromagnet 318 with the biasing member 304 to dynamically control the opening and closing of the deployable door 102. When the electronic device is powered on and/or when there is no media program operating, neither of the first electromagnet 316 (EM1) or the second electromagnet 318 (EM2) is energized, as shown in FIG. 4A. The biasing member 304 includes an example link 402, which is magnetically attracted to the permanent magnet 314 (N). The link 402 includes a ferromagnetic material so that the link 402 is magnetically attracted to magnets.

When a media program is played, the trigger circuitry 204 causes an electric current to flow to the first electromagnet 316 (EM1) to energize the first electromagnet 316 (EM1) as shown in FIG. 4B. When the first electromagnet 316 (EM1) is energized, a first magnetic field is produced, which temporarily attracts the link 402 towards the first electromagnet 316 (EM1). When the link 402 is attracted to the first electromagnet 316 (EM1), the biasing member 304 pivots, which opens the deployable door 102.

When the media file ceases, is paused, muted, and/or otherwise stopped, trigger circuitry 204 causes the electric current to stop flowing to the first electromagnet 316 (EM1). In this operating condition, the trigger circuitry 204 causes an electric current to flow to the second electromagnet 318 (EM2) to energize the second electromagnet 318 (EM2) as shown in FIG. 4C. When the second electromagnet 318 (EM2) is energized, a second magnetic field is produced, which temporarily repels the link 402 away from the first electromagnet 316 (EM1) and the second electromagnet 318 (EM2) and toward the permanent magnet 314 (N). When the link 402 is repelled from the first electromagnet 316 (EM1) and the second electromagnet 318 (EM2), the biasing member 304 pivots, which closes the deployable door 102.

To effect both movements, the trigger circuitry 204 causes pulses of electrical current to respective ones of the first electromagnet 316 (EM1) or the second electromagnet 318 (EM2). A continue energy supply to the first electromagnet 316 (EM1) and/or the second electromagnet 318 (EM2) is not required to cause the deployable door 102 to move between the first (closed) position and the second (open) position.

FIG. 2 is a block diagram of an example implementation of the audio duct configuration circuitry 200 of FIG. 1 to configure the position of the deployable door 102 based on an operating state and/or volume state of a media program. The audio duct configuration circuitry 200 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the audio duct configuration circuitry 200 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

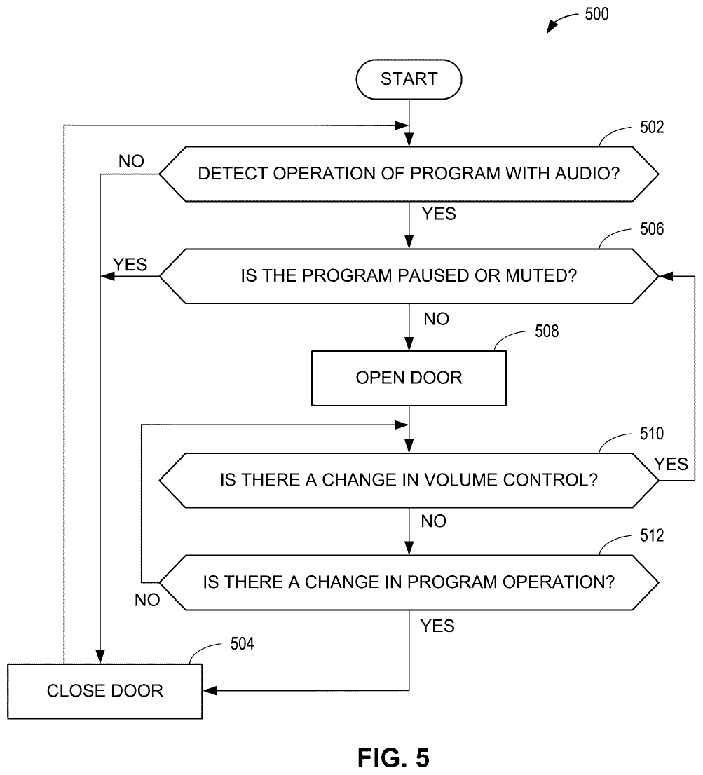

In some examples, the audio duct configuration circuitry 200 including the detection circuitry 202 and the trigger circuitry 204 are instantiated by programmable circuitry executing audio duct configuration instructions and/or configured to perform operations such as those represented by the flowchart of FIG. 5.

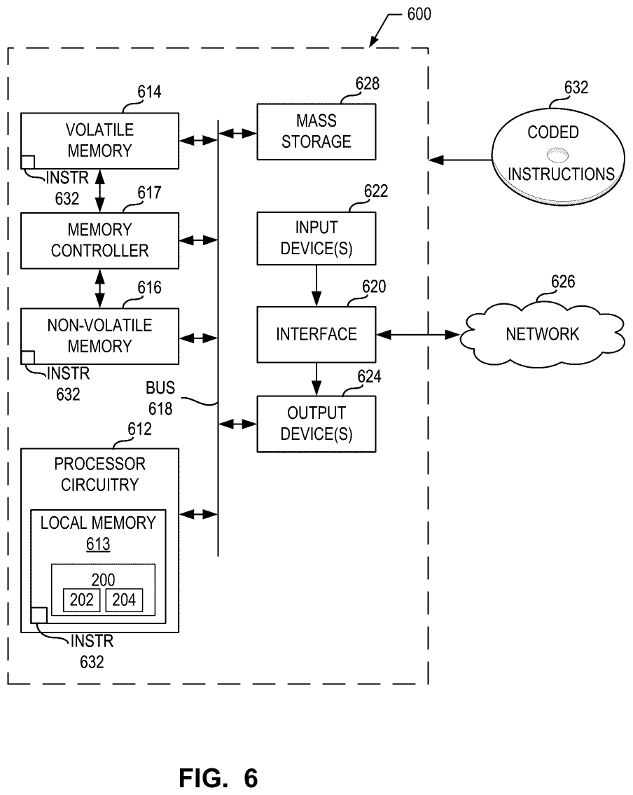

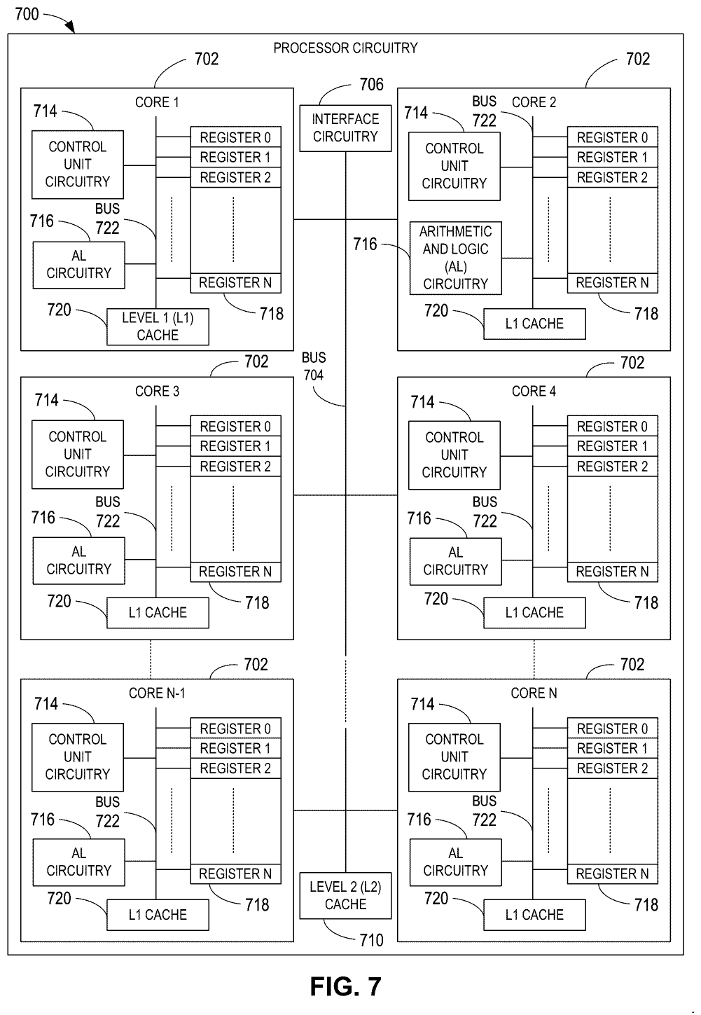

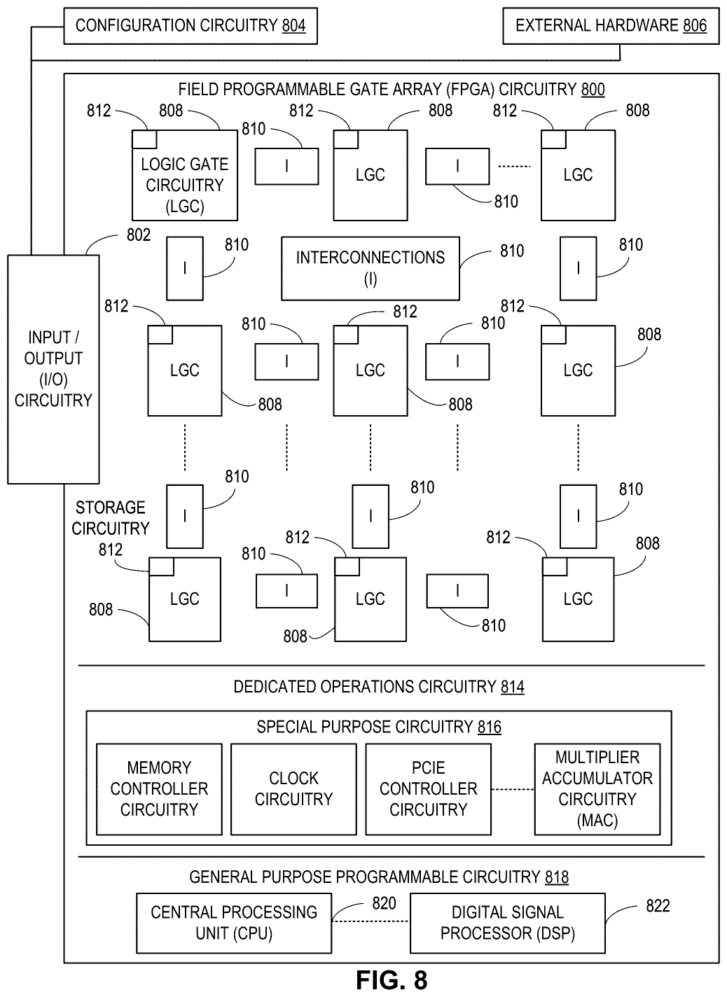

In some examples, the audio duct configuration circuitry 200 includes means for configuring an audio duct including positioning of a deployable door. For example, the means for configuring may be implemented by the audio duct configuration circuitry 200. In some examples, the audio duct configuration circuitry 200 may be instantiated by programmable circuitry such as the example programmable circuitry 712 of FIG. 7. For instance, the audio duct configuration circuitry 200 may be instantiated by the example microprocessor 600 of FIG. 6 executing machine executable instructions such as those implemented by at least blocks 702, 704 of FIG. 7. In some examples, the audio duct configuration circuitry 200 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the audio duct configuration circuitry 200 may be instantiated by any other combination of hardware, software, and/or firmware. For example, the audio duct configuration circuitry 200 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the means for configuring an audio duct includes means for determining an operating state and/or volume state of a media program (e.g., the detection circuitry 202) and/or means for triggering an actuator to reposition the deployable door 102 (e.g., the trigger circuitry 204).

While an example manner of implementing the audio duct configuration circuitry 200 of FIG. 1 is illustrated in FIG. 2, one or more of the elements, processes, and/or devices illustrated in FIG. 2 may be combined, divided, re-arranged, omitted, eliminated, and/or implemented in any other way. Further, the example detection circuitry 202, the example trigger circuitry 204, and/or, more generally, the example audio duct configuration circuitry 200 of FIG. 2, may be implemented by hardware alone or by hardware in combination with software and/or firmware. Thus, for example, any of the example detection circuitry 202, the example trigger circuitry 204, and/or, more generally, the example audio duct configuration circuitry 200, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example audio duct configuration circuitry 200 of FIG. 2 may include one or more elements, processes, and/or devices in addition to, or instead of, those illustrated in FIG. 2, and/or may include more than one of any or all of the illustrated elements, processes and devices.

Flowchart(s) representative of example machine readable instructions, which may be executed by programmable circuitry to implement and/or instantiate the audio duct configuration circuitry 200 of FIG. 2 and/or representative of example operations which may be performed by programmable circuitry to implement and/or instantiate the audio duct configuration circuitry 200 of FIG. 2, are shown in FIG. 5. The machine readable instructions may be one or more executable programs or portion(s) of one or more executable programs for execution by programmable circuitry such as the programmable circuitry 712 shown in the example processor platform 700 discussed below in connection with FIG. 7 and/or may be one or more function(s) or portion(s) of functions to be performed by the example programmable circuitry (e.g., an FPGA) discussed below in connection with FIGS. 6 and/or 8. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIG. 5, many other methods of implementing the example audio duct configuration circuitry 200 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 5 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 5 is a flowchart representative of example machine readable instructions and/or example operations 500 that may be executed, instantiated, and/or performed by programmable circuitry to configure an audio duct in an electronic device. The example machine-readable instructions and/or the example operations 500 of FIG. 5 include the detection circuitry 202 of the audio duct configuration circuitry 200 detecting operation of a program that includes audio (block 502). If or when operation of a program with audio is not detected (block 502: NO), the trigger circuitry 204 of the audio configuration circuitry 200 closes the deployable door 102 (or causes closure of the deployable door 102) or maintains the deployable door 102 (or causes maintenance of the deployable door 102) in the closed position (block 504).

If or when operation of a program with audio is detected (block 502: YES), the detection circuitry 202 determines if the program is paused and/or muted (block 506). If or when the detection circuitry 202 determines that the program is paused and/or muted (block 506: YES), the trigger circuitry 204 of the audio configuration circuitry 200 closes the deployable door 102 or causes closure of the deployable door 102 (block 504).

If or when the detection circuitry 202 determines that the program is not paused nor muted (block 506: NO), the trigger circuitry 204 of the audio configuration circuitry 200 opens the deployable door 102 or causes opening of the deployable door 102 (block 508).

The example process 500 includes the detection circuitry 202 monitoring for a change in a volume control (e.g., a pausing or muting of the program) (block 510). If or when there is a change in a volume control (block 510: YES), the process 500 continues with the detection circuitry 202 determining if the program has been paused and/or muted (block 506). If or when there is not a change in a volume control (block 510: NO), the detection circuitry 202 monitors to determine if there is a change in program operation (e.g., a cessation or closing of the program) (block 512).

If or when there is not a change in the program operation (block 512: NO), the process 500 continues with the detection circuitry 202 monitoring to determine if there is a change in a volume control (block 510). If or when there is a change in the program operation (block 512: YES), the trigger circuitry 204 of the audio configuration circuitry 200 closes the deployable door 102 or causes closure of the deployable door 102 (block 504).

FIG. 6 is a block diagram of an example programmable circuitry platform 600 structured to execute and/or instantiate the example machine-readable instructions and/or the example operations of FIG. 5 to implement the audio duct configuration circuitry 200 of FIG. 2. The programmable circuitry platform 600 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 600 of the illustrated example includes programmable circuitry 612. The programmable circuitry 612 of the illustrated example is hardware. For example, the programmable circuitry 612 can be implemented by one or more integrated circuits, logic circuits, FPGAS, microprocessors, CPUs, GPUs, DSPs, and/or microcontrollers from any desired family or manufacturer. The programmable circuitry 612 may be implemented by one or more semiconductor based (e.g., silicon based) devices. In this example, the programmable circuitry 712 implements the example detection circuitry 202, the example trigger circuitry 204, and the example audio duct configuration circuitry 204.

The programmable circuitry 612 of the illustrated example includes a local memory 613 (e.g., a cache, registers, etc.). The programmable circuitry 612 of the illustrated example is in communication with main memory 614, 616, which includes a volatile memory 614 and a non-volatile memory 616, by a bus 618. The volatile memory 614 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 616 may be implemented by flash memory and/or any other desired type of memory device. Access to the main memory 614, 616 of the illustrated example is controlled by a memory controller 616. In some examples, the memory controller 616 may be implemented by one or more integrated circuits, logic circuits, microcontrollers from any desired family or manufacturer, or any other type of circuitry to manage the flow of data going to and from the main memory 614, 616.

The programmable circuitry platform 600 of the illustrated example also includes interface circuitry 620. The interface circuitry 620 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 622 are connected to the interface circuitry 620. The input device(s) 622 permit(s) a user (e.g., a human user, a machine user, etc.) to enter data and/or commands into the programmable circuitry 612. The input device(s) 622 can be implemented by, for example, an audio sensor, a microphone, a camera (still or video), a keyboard, a button, a mouse, a touchscreen, a trackpad, a trackball, an isopoint device, and/or a voice recognition system.

One or more output devices 624 are also connected to the interface circuitry 620 of the illustrated example. The output device(s) 624 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 620 of the illustrated example, thus, typically includes a graphics driver card, a graphics driver chip, and/or graphics processor circuitry such as a GPU.

The interface circuitry 620 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 626. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 600 of the illustrated example also includes one or more mass storage discs or devices 628 to store firmware, software, and/or data. Examples of such mass storage discs or devices 628 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 632, which may be implemented by the machine readable instructions of FIG. 5, may be stored in the mass storage device 628, in the volatile memory 614, in the non-volatile memory 616, and/or on at least one non-transitory computer readable storage medium such as a CD or DVD which may be removable.

FIG. 7 is a block diagram of an example implementation of the programmable circuitry 612 of FIG. 6. In this example, the programmable circuitry 612 of FIG. 6 is implemented by a microprocessor 700. For example, the microprocessor 700 may be a general-purpose microprocessor (e.g., general-purpose microprocessor circuitry). The microprocessor 700 executes some or all of the machine-readable instructions of the flowchart of FIG. 5 to effectively instantiate the circuitry of FIG. 2 as logic circuits to perform operations corresponding to those machine readable instructions. In some such examples, the circuitry of FIG. 2 is instantiated by the hardware circuits of the microprocessor 700 in combination with the machine-readable instructions. For example, the microprocessor 700 may be implemented by multi-core hardware circuitry such as a CPU, a DSP, a GPU, an XPU, etc. Although it may include any number of example cores 702 (e.g., 1 core), the microprocessor 700 of this example is a multi-core semiconductor device including N cores. The cores 702 of the microprocessor 700 may operate independently or may cooperate to execute machine readable instructions. For example, machine code corresponding to a firmware program, an embedded software program, or a software program may be executed by one of the cores 702 or may be executed by multiple ones of the cores 702 at the same or different times. In some examples, the machine code corresponding to the firmware program, the embedded software program, or the software program is split into threads and executed in parallel by two or more of the cores 702. The software program may correspond to a portion or all of the machine readable instructions and/or operations represented by the flowcharts of FIG. 5.

The cores 702 may communicate by a first example bus 704. In some examples, the first bus 704 may be implemented by a communication bus to effectuate communication associated with one(s) of the cores 702. For example, the first bus 704 may be implemented by at least one of an Inter-Integrated Circuit (I2C) bus, a Serial Peripheral Interface (SPI) bus, a PCI bus, or a PCIe bus. Additionally or alternatively, the first bus 704 may be implemented by any other type of computing or electrical bus. The cores 702 may obtain data, instructions, and/or signals from one or more external devices by example interface circuitry 706. The cores 702 may output data, instructions, and/or signals to the one or more external devices by the interface circuitry 706. Although the cores 702 of this example include example local memory 720 (e.g., Level 1 (L1) cache that may be split into an L1 data cache and an L1 instruction cache), the microprocessor 700 also includes example shared memory 710 that may be shared by the cores (e.g., Level 2 (L2 cache)) for high-speed access to data and/or instructions. Data and/or instructions may be transferred (e.g., shared) by writing to and/or reading from the shared memory 710. The local memory 720 of each of the cores 702 and the shared memory 710 may be part of a hierarchy of storage devices including multiple levels of cache memory and the main memory (e.g., the main memory 614, 616 of FIG. 6). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 702 may be referred to as a CPU, DSP, GPU, etc., or any other type of hardware circuitry. Each core 702 includes control unit circuitry 714, arithmetic and logic (AL) circuitry (sometimes referred to as an ALU) 716, a plurality of registers 718, the local memory 720, and a second example bus 722. Other structures may be present. For example, each core 702 may include vector unit circuitry, single instruction multiple data (SIMD) unit circuitry, load/store unit (LSU) circuitry, branch/jump unit circuitry, floating-point unit (FPU) circuitry, etc. The control unit circuitry 714 includes semiconductor-based circuits structured to control (e.g., coordinate) data movement within the corresponding core 702. The AL circuitry 716 includes semiconductor-based circuits structured to perform one or more mathematic and/or logic operations on the data within the corresponding core 702. The AL circuitry 617 of some examples performs integer based operations. In other examples, the AL circuitry 716 also performs floating-point operations. In yet other examples, the AL circuitry 716 may include first AL circuitry that performs integer-based operations and second AL circuitry that performs floating-point operations. In some examples, the AL circuitry 716 may be referred to as an Arithmetic Logic Unit (ALU).

The registers 718 are semiconductor-based structures to store data and/or instructions such as results of one or more of the operations performed by the AL circuitry 716 of the corresponding core 702. For example, the registers 718 may include vector register(s), SIMD register(s), general-purpose register(s), flag register(s), segment register(s), machine-specific register(s), instruction pointer register(s), control register(s), debug register(s), memory management register(s), machine check register(s), etc. The registers 718 may be arranged in a bank as shown in FIG. 7. Alternatively, the registers 718 may be organized in any other arrangement, format, or structure, such as by being distributed throughout the core 702 to shorten access time. The second bus 722 may be implemented by at least one of an I2C bus, a SPI bus, a PCI bus, or a PCIe bus.

Each core 702 and/or, more generally, the microprocessor 700 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 700 is a semiconductor device fabricated to include many transistors interconnected to implement the structures described above in one or more integrated circuits (ICs) contained in one or more packages.

The microprocessor 700 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 700, in the same chip package as the microprocessor 700 and/or in one or more separate packages from the microprocessor 700.

FIG. 8 is a block diagram of another example implementation of the programmable circuitry 612 of FIG. 6. In this example, the programmable circuitry 612 is implemented by FPGA circuitry 800. For example, the FPGA circuitry 800 may be implemented by an FPGA. The FPGA circuitry 800 can be used, for example, to perform operations that could otherwise be performed by the example microprocessor 700 of FIG. 7 executing corresponding machine readable instructions. However, once configured, the FPGA circuitry 800 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 700 of FIG. 7 described above (which is a general purpose device that may be programmed to execute some or all of the machine readable instructions represented by the flowchart of FIG. 5 but whose interconnections and logic circuitry are fixed once fabricated), the FPGA circuitry 800 of the example of FIG. 8 includes interconnections and logic circuitry that may be configured, structured, programmed, and/or interconnected in different ways after fabrication to instantiate, for example, some or all of the operations/functions corresponding to the machine readable instructions represented by the flowchart of FIG. 5. In particular, the FPGA circuitry 800 may be thought of as an array of logic gates, interconnections, and switches. The switches can be programmed to change how the logic gates are interconnected by the interconnections, effectively forming one or more dedicated logic circuits (unless and until the FPGA circuitry 800 is reprogrammed). The configured logic circuits enable the logic gates to cooperate in different ways to perform different operations on data received by input circuitry. Those operations may correspond to some or all of the instructions (e.g., the software and/or firmware) represented by the flowchart of FIG. 5. As such, the FPGA circuitry 800 may be configured and/or structured to effectively instantiate some or all of the operations/functions corresponding to the machine readable instructions of the flowchart of FIG. 5 as dedicated logic circuits to perform the operations/functions corresponding to those software instructions in a dedicated manner analogous to an ASIC. Therefore, the FPGA circuitry 800 may perform the operations/functions corresponding to the some or all of the machine readable instructions of FIG. 5 faster than the general-purpose microprocessor can execute the same.

In the example of FIG. 8, the FPGA circuitry 800 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 800 of FIG. 8 may access and/or load the binary file to cause the FPGA circuitry 800 of FIG. 8 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 800 of FIG. 8 to cause configuration and/or structuring of the FPGA circuitry 800 of FIG. 8, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 800 of FIG. 8 may access and/or load the binary file to cause the FPGA circuitry 800 of FIG. 8 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 800 of FIG. 8 to cause configuration and/or structuring of the FPGA circuitry 800 of FIG. 8, or portion(s) thereof.

The FPGA circuitry 800 of FIG. 8, includes example input/output (I/O) circuitry 802 to obtain and/or output data to/from example configuration circuitry 804 and/or external hardware 806. For example, the configuration circuitry 804 may be implemented by interface circuitry that may obtain a binary file, which may be implemented by a bit stream, data, and/or machine-readable instructions, to configure the FPGA circuitry 800, or portion(s) thereof. In some such examples, the configuration circuitry 804 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 806 may be implemented by external hardware circuitry. For example, the external hardware 806 may be implemented by the microprocessor 700 of FIG. 7.

The FPGA circuitry 800 also includes an array of example logic gate circuitry 808, a plurality of example configurable interconnections 810, and example storage circuitry 812. The logic gate circuitry 808 and the configurable interconnections 810 are configurable to instantiate one or more operations/functions that may correspond to at least some of the machine readable instructions of FIG. 5 and/or other desired operations. The logic gate circuitry 808 shown in FIG. 8 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 808 to enable configuration of the electrical structures and/or the logic gates to form circuits to perform desired operations/functions. The logic gate circuitry 808 may include other electrical structures such as look-up tables (LUTs), registers (e.g., flip-flops or latches), multiplexers, etc.

The configurable interconnections 810 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 808 to program desired logic circuits.

The storage circuitry 812 of the illustrated example is structured to store result(s) of the one or more of the operations performed by corresponding logic gates. The storage circuitry 812 may be implemented by registers or the like. In the illustrated example, the storage circuitry 812 is distributed amongst the logic gate circuitry 808 to facilitate access and increase execution speed.

The example FPGA circuitry 800 of FIG. 8 also includes example dedicated operations circuitry 814. In this example, the dedicated operations circuitry 814 includes special purpose circuitry 816 that may be invoked to implement commonly used functions to avoid the need to program those functions in the field. Examples of such special purpose circuitry 816 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 800 may also include example general purpose programmable circuitry 818 such as an example CPU 820 and/or an example DSP 822. Other general purpose programmable circuitry 818 may additionally or alternatively be present such as a GPU, an XPU, etc., that can be programmed to perform other operations.

Although FIGS. 7 and 8 illustrate two example implementations of the programmable circuitry 612 of FIG. 6, many other approaches are contemplated. For example, FPGA circuitry may include an on-board CPU, such as one or more of the example CPU 820 of FIG. 8. Therefore, the programmable circuitry 612 of FIG. 6 may additionally be implemented by combining at least the example microprocessor 700 of FIG. 7 and the example FPGA circuitry 800 of FIG. 8. In some such hybrid examples, one or more cores 702 of FIG. 7 may execute a first portion of the machine readable instructions represented by the flowchart of FIG. 5 to perform first operation(s)/function(s), the FPGA circuitry 800 of FIG. 8 may be configured and/or structured to perform second operation(s)/function(s) corresponding to a second portion of the machine readable instructions represented by the flowcharts of FIG. 5, and/or an ASIC may be configured and/or structured to perform third operation(s)/function(s) corresponding to a third portion of the machine readable instructions represented by the flowchart of FIG. 5.

It should be understood that some or all of the circuitry of FIG. 2 may, thus, be instantiated at the same or different times. For example, same and/or different portion(s) of the microprocessor 700 of FIG. 7 may be programmed to execute portion(s) of machine-readable instructions at the same and/or different times. In some examples, same and/or different portion(s) of the FPGA circuitry 800 of FIG. 8 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 700 of FIG. 7 may execute machine readable instructions in one or more threads executing concurrently and/or in series. In some examples, the FPGA circuitry 800 of FIG. 8 may be configured and/or structured to carry out operations/functions concurrently and/or in series. Moreover, in some examples, some or all of the circuitry of FIG. 2 may be implemented within one or more virtual machines and/or containers executing on the microprocessor 700 of FIG. 7.

In some examples, the programmable circuitry 612 of FIG. 6 may be in one or more packages. For example, the microprocessor 700 of FIG. 7 and/or the FPGA circuitry 800 of FIG. 8 may be in one or more packages. In some examples, an XPU may be implemented by the programmable circuitry 612 of FIG. 6, which may be in one or more packages. For example, the XPU may include a CPU (e.g., the microprocessor 700 of FIG. 7, the CPU 820 of FIG. 8, etc.) in one package, a DSP (e.g., the DSP 822 of FIG. 8) in another package, a GPU in yet another package, and an FPGA (e.g., the FPGA circuitry 800 of FIG. 8) in still yet another package.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that configure audio ducts of electronic devices. Disclosed systems, apparatus, articles of manufacture, and methods improve the efficiency of using a computing device by preventing dust or debris from ingress into the electronic device, which increases the longevity and extended performance of the devices over its lifespan. The disclosed system, apparatus, articles of manufacture and methods also improve the user experience by presenting higher quality audio to the user. Disclosed systems, apparatus, articles of manufacture, and methods are accordingly directed to one or more improvement(s) in the operation of a machine such as a computer or other electronic and/or mechanical device.

Top porting of speakers cannot be achieved with narrow bezels for tablets and/or dual display devices. In addition, the use case of these tablets and/or dual display device prevent the use of top firing or top ported speakers because a user's hand will cover the speaker grills and there is insufficient space on the side bezels to place the speakers unless the system dimension is increased.

Examples disclosed herein allow for enhance audio experience with a low cost design that does not require increasing the numbers of speakers and amplifiers (and, thus, increasing the cost) and/or increasing the thickness or z-height of the electronic device.

Examples disclosed herein improve audio performance and quality of the electronic devices. Examples disclosed herein improved the high frequency response at the user position by re-directing the sound stage towards the user through the deployable doors that are coupled to the speaker side port. As disclosed herein, the deployable doors are part of the chassis and direct the sound waves in a direction facing towards the user, which improves audio quality. In some examples, there is an increase of about 4 dB for frequencies between about 6 KHz and about 10 KHz.

In some examples, a side of the electronic device may include a bevel orientated downward, toward a support surface. Example deployable doors disclosed herein also may positioned on the lower facing bevel surface and used to reflect audio upward and forward toward the user. Thus, examples disclosed herein may be used with bottom ported speakers.

In some examples, the electronic device may include a manual override that may be actuated to open and/or close the deployable door.

Disclosed herein are example systems, apparatus, articles of manufacture, and methods for configuring audio ducts of electronic devices. Example 1 is an electronic device that includes: a chassis; a speaker; an audio duct formed on an edge of the chassis; and a deployable door movable between a first position adjacent the chassis and covering the audio duct and a second position exposing the audio duct.

Example 2 includes the electronic device of Example 1, wherein the deployable door is pivotably coupled to the chassis.

Example 3 includes the electronic device of Example 2, wherein the deployable door includes: a first end coupled to the chassis in the first position and the second position; and a second end positioned against the chassis in the first position and positioned away from the chassis in the second position, the deployable door to direct sound from the speaker to a user of the electronic device.

Example 4 includes the electronic device of any of Examples 1-3, wherein the deployable door is deployable from a bottom of the chassis, the deployable door to direct sound from the speaker to a user of the electronic device.

Example 5 includes the electronic device of any of Examples 1-4, further including a spring to bias the deployable door to the second position.

Example 6 includes the electronic device of any of Examples 1-5, further including an electromagnet to move the deployable door between the first position and the second position.

Example 7 includes the electronic device of Example 6, further including programmable circuitry to cause electricity to energize the electromagnet to move the deployable door between the first position and the second position.

Example 8 includes the electronic device of Example 7, wherein the programmable circuitry is to identify operation of a media program and cause the electricity to energize the electromagnet based on the operation of the media program.

Example 9 includes the electronic device of any of Examples 6-8, further including a link operably coupled with the deployable door, the electromagnet to attract the link to move the deployable door to the second position.

Example 10 includes the electronic device of any of Examples 6-9, further including a link operably coupled with the deployable door, the electromagnet to repel the link to move the deployable door to the first position.

Example 11 includes the electronic device of any of Examples 1-10, further including: a magnet; a first electromagnet; a second electromagnet; and a link, the first electromagnet to pull the link from the magnet when the first electromagnet is energized to move the deployable door to the second position, and the second electromagnet to repel the link when the second electromagnet is energized and the magnet to attract the link to move the deployable door to the first position.

Example 12 includes the electronic device of Example 11, wherein the link is ferromagnetic.

Example 13 includes the electronic device of either of Examples 11 or 12, wherein the chassis includes a lid and a base, the magnet to releasably hold the lid to the base when the electronic device is in a closed position.

Example 14 includes the electronic device of any of Examples 11-13, further including programmable circuitry to: cause electricity to energize the first electromagnet to move the deployable door to the second position; and cause electricity to energize the second electromagnet to move the deployable door to the first position.

Example 15 is an electronic device that includes: machine readable instructions; and programmable circuitry to at least one of instantiate or execute the machine readable instructions to: detect use of a media program; and trigger deployment of a door covering an audio duct to expose the audio duct based on use of the media program.

Example 16 includes the electronic device of Example 15, wherein to trigger deployment of the door, the programmable circuitry is to cause electricity to energize an electromagnet.

Example 17 includes the electronic device of either of Examples 15 or 16, wherein the programmable circuitry is to: detect cessation of the media program; and trigger retraction of the door to conceal the audio duct based on cessation of the media program.

Example 18 includes the electronic device of any of Examples 15-17, wherein the programmable circuitry is to: detect muting of the media program; and trigger retraction of the door to conceal the audio duct based on muting of the media program.

Example 19 is a non-transitory machine readable storage medium that includes instructions to cause programmable circuitry to at least: detect an operating mode of a media application on an electronic device; and cause movement of a door covering a speaker duct between a first position to expose an audio duct and a second position to conceal the audio duct based the operating mode of the media application, wherein the programmable circuitry is to move the door to the first position when the operating mode is an active mode and an unmuted mode, and the programmable circuitry is to move the door to the second position when the operating mode is an inactive mode, a pause mode, or a mute mode.

Example 20 includes the non-transitory machine readable storage medium of Example 19, wherein to cause the movement of the door, the programmable circuitry is to cause an electromagnet to be energized.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An electronic device comprising:
a chassis;
a speaker;
an audio duct formed on an edge of the chassis; and
a deployable door movable between a first position adjacent the chassis and covering the audio duct and a second position exposing the audio duct.

2. The electronic device of claim 1, wherein the deployable door is pivotably coupled to the chassis.

3. The electronic device of claim 2, wherein the deployable door includes:
a first end coupled to the chassis in the first position and the second position; and
a second end positioned against the chassis in the first position and positioned away from the chassis in the second position, the deployable door to direct sound from the speaker to a user of the electronic device.

4. The electronic device of claim 1, wherein the deployable door is deployable from a bottom of the chassis, the deployable door to direct sound from the speaker to a user of the electronic device.

5. The electronic device of claim 1, further including a spring to bias the deployable door to the second position.

6. The electronic device of claim 1, further including an electromagnet to move the deployable door between the first position and the second position.

7. The electronic device of claim 6, further including programmable circuitry to cause electricity to energize the electromagnet to move the deployable door between the first position and the second position.

8. The electronic device of claim 7, wherein the programmable circuitry is to identify operation of a media program and cause the electricity to energize the electromagnet based on the operation of the media program.

9. The electronic device of claim 6, further including a link operably coupled with the deployable door, the electromagnet to attract the link to move the deployable door to the second position.

10. The electronic device of claim 6, further including a link operably coupled with the deployable door, the electromagnet to repel the link to move the deployable door to the first position.

11. The electronic device of claim 1, further including:
a magnet;
a first electromagnet;
a second electromagnet; and
a link, the first electromagnet to pull the link from the magnet when the first electromagnet is energized to move the deployable door to the second position, and the second electromagnet to repel the link when the second electromagnet is energized and the magnet to attract the link to move the deployable door to the first position.

12. The electronic device of claim 11, wherein the link is ferromagnetic.

13. The electronic device of claim 11, wherein the chassis includes a lid and a base, the magnet to releasably hold the lid to the base when the electronic device is in a closed position.

14. The electronic device of claim 11, further including programmable circuitry to:
cause electricity to energize the first electromagnet to move the deployable door to the second position; and
cause electricity to energize the second electromagnet to move the deployable door to the first position.

15. An electronic device comprising:
machine readable instructions; and
programmable circuitry to at least one of instantiate or execute the machine readable instructions to:
detect use of a media program; and
trigger deployment of a door covering an audio duct to expose the audio duct based on use of the media program.

16. The electronic device of claim 15, wherein to trigger deployment of the door, the programmable circuitry is to cause electricity to energize an electromagnet.

17. The electronic device of claim 15, wherein the programmable circuitry is to:
detect cessation of the media program; and
trigger retraction of the door to conceal the audio duct based on cessation of the media program.

18. The electronic device of claim 15, wherein the programmable circuitry is to:
detect muting of the media program; and
trigger retraction of the door to conceal the audio duct based on muting of the media program.

19. A non-transitory machine readable storage medium comprising instructions to cause programmable circuitry to at least:
detect an operating mode of a media application on an electronic device; and
cause movement of a door covering a speaker duct between a first position to expose an audio duct and a second position to conceal the audio duct based the operating mode of the media application, wherein the programmable circuitry is to move the door to the first position when the operating mode is an active mode and an unmuted mode, and the programmable circuitry is to move the door to the second position when the operating mode is an inactive mode, a pause mode, or a mute mode.

20. The non-transitory machine readable storage medium of claim 19, wherein to cause the movement of the door, the programmable circuitry is to cause an electromagnet to be energized.
